(19) United States
(12) Patent Application Publication
(10) Pub. No.: US 2024/0338534 A1
(43) Pub. Date: Oct. 10, 2024

(54) NATURAL LANGUAGE TO APPLICATION PROGRAMMING INTERFACE TRANSLATION

(71) Applicant: Expedia, Inc., Seattle, WA (US)

(72) Inventor: Bogdan Popp, Kirkland, WA (US)

(21) Appl. No.: 18/497,304

(22) Filed: Oct. 30, 2023

Related U.S. Application Data
(60) Provisional application No. 63/494,597, filed on Apr. 6, 2023.

(51) Int. Cl. G06F 40/58; G06F 9/54; G06F 40/51

(52) U.S. Cl. CPC G06F 40/58; G06F 9/543; G06F 40/51

(57) ABSTRACT

Systems and methods are provided for obtaining a corpus of training data based on a plurality of natural language processing sessions, wherein the corpus of training data comprises a plurality of training data input vectors and a plurality of reference data output vectors, wherein a reference data output vector of the plurality of reference data output vectors represents a travel-based search request as a desired output to be generated from a training data input vector, of the plurality of training data input vectors, representing a natural language query regarding a travel reservation, training a natural-language-to-API model using the corpus of training data, wherein the natural-language-to-API model is trained to generate predicted travel-bases search requests using natural language query input.

### CROSS-REFERENCE TO RELATED APPLICATION

The present application claims priority to U.S. Provisional Patent Application No. 63/494,597, filed on Apr. 6, 2023, the content of which is incorporated by reference herein and made part of this specification.

### BACKGROUND

Natural language processing systems include various components for receiving input from a user and processing the input to determine what the user means. In some implementations, a natural language processing system receives textual input, such as text entered by a user or a transcription of a user's utterance. The natural language processing system can determine the meaning of the textual input in a way that can be acted upon by a computer application.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a diagram of an illustrative natural language processing system with various components for processing natural language queries from user devices according to some embodiments.

FIG. 2 is a flow diagram of an illustrative routine for generating training data and training a machine learning model according to some embodiments.

FIG. 3 is a diagram of a natural language processing session and development of parameters for an application programming interface request based thereon according to some embodiments.

FIG. 4 is a diagram of another natural language processing session and development of parameters for an application programming interface request based thereon according to some embodiments.

FIG. 5 is a flow diagram of an illustrative routine for orchestrating natural language processing sessions using a dialog-based query parameter manager or a machine learning model according to some embodiments.

FIG. 6 is a diagram of a natural language processing session with generation of an application programming interface request using a machine learning model according to some embodiments.

FIG. 7 is a block diagram of an illustrative computing system configured to implement aspects of the present disclosure according to some embodiments.

### DETAILED DESCRIPTION

The present disclosure is directed to using a natural language query processing pipeline to generate training data for training a machine learning model. The machine learning model may be trained using the training data to translate natural language queries into computer-executable requests. Additionally, the present disclosure is directed to orchestration of natural language query processing across different pipelines to evaluate and improve the performance of the machine learning model trained to translate natural language queries into computer-executable requests.

Some conventional computing systems offer natural language user interfaces that allow users to access system functionality and otherwise interact with the systems using spoken or typed inputs that approximate conversational language. These inputs may be referred to as natural language queries or natural language requests (even if phrased as commands or otherwise not in the form of questions). Some examples of systems that provide such interfaces include travel booking systems, search engines, customer service systems, and the like. The systems may use interactive, multi-turn dialog interfaces to obtain information needed to generate and execute application programming interface (API) requests in response to natural language queries from users. For example, some systems use natural language processing (NLP) to determine the intent behind a user's query, and to determine a corresponding executable request that the system is to execute to provide information or take an action responsive to the user's intent. Some systems may use a database of questions or prompts to obtain parameters or other information for executing the request, while other systems may use natural language generation (NLG) processing (e.g., generative artificial intelligence) to generate natural language prompts and otherwise manage a dialog. Each system prompt and corresponding user response may be referred to as a single “turn” of a multi-turn dialog. These systems typically take multiple turns to obtain the parameters needed to respond to requests. In some cases, the systems may fail to obtain some parameters even after engaging in multiple dialog turns. As a result, the performance of the systems—defined in terms of computing resource efficiency, processing accuracy, latency, or user experience—can be unsatisfactory.

Some aspects of the present disclosure address some or all of the issues noted above, among others, through use of a machine learning model that translates natural language queries into API requests. Advantageously, such a model can be trained to generate API requests from natural language queries with fewer dialog turns after users' initial natural language queries, or directly into API requests with no additional dialog turns at all. To obtain training data for training such a model, a multi-turn dialog pipeline may be used to manage natural language processing sessions, process natural language queries, obtain parameters, and generate API requests in response to the natural language queries. The initial natural language queries, resulting API requests, and optionally other information about the natural language processing sessions may be stored and used to train a model to generate API requests from initial natural language queries.

Additional aspects of the present disclosure relate to distributing natural language queries among different processing pipelines, evaluating the performance of each pipeline, and adjusting aspects of individual pipelines based on their performance. In some embodiments, one pipeline may use a machine learning model that has been trained to generate API requests in response to natural language queries with few (or no) additional dialog turns, and another pipeline may be or include the multi-turn chat-based dialog pipeline that was used to obtain data to train the machine learning model. Advantageously, when the performance of one of the pipelines, such as the machine learning model pipeline, falls below a performance threshold, the machine learning model may be retrained or the pipeline may be otherwise modified to improve its performance. In some embodiments, there may be multiple machine learning model pipelines (e.g., using different types of models, models trained using different data, etc.), multiple chat-based dialog pipelines, or any combination of each.

An orchestration system, also referred to herein as an orchestrator, may determine which pipelines, of the multiple available request processing pipelines, are to process and respond to each of the natural language queries that are received. The orchestrator or components of the individual pipelines may store data regarding the natural language processing, such as the natural language query input, the number of dialog turns needed to generate an API request, user actions taken based on results of the API request, and the like. Based on this data, the performance of individual pipelines—defined in terms of computing resource efficiency, processing accuracy, latency, or user experience—can be determined, and remediations may be implemented.

With reference to an illustrative embodiment, a multi-turn chat-based dialog pipeline (also referred to simply as a “dialog-based pipeline” for brevity) may be implemented for processing and responding to natural language queries. The queries to be handled by the dialog-based pipeline may relate to travel activities and reservations, such as hotels, airfare, rental cars, or packages of such activities. The dialog-based pipeline may be configured to generate API requests, such as computer-executable search queries to obtain data responsive to user travel queries. As used herein, the terms “natural language query” and “natural language request” are not necessarily limited to questions, but may also include other statements made by a user to prompt a response or other action. For example, a user may initiate a natural language processing session by speaking or typing a statement such as “Show me travel packages for my family over Thanksgiving.” Although not phrased as a question, it is understood that the user would like to research possible travel packages that relate to the stated criteria.

The dialog-based pipeline may include natural language understanding (NLU) components that evaluate text of the query either as typed by the user, or as generated by an automatic speech recognition (ASR) component of the dialog-based pipeline. An NLU processing component may identify particular words or phrases in the query that reveal the intent of the user in making the query, and provide details regarding the intent. These words or phrases may be referred to as “named entities,” and the NLU processing component that identifies them may be referred to as a named entity recognition (NER) component. In the present example, an NER component may identify the intent as “search travel packages,” and may identify additional entities such as a “departure date” entity (based on the “over Thanksgiving” phrase) and a “number of travelers” entity (based on the “my family” phrase).

To respond to the “search travel packages” intent and therefore to respond to the user's natural language query, the dialog-based pipeline may determine whether additional parameters are needed or whether identified parameters are to be confirmed in order to generate an API request. The parameters for the API request may correspond to particular named entities. For example, a “search travel packages” intent may require a “departure date” parameter and a “number of travelers” parameter that a user may specify via corresponding named entities. In addition, the “search travel packages” intent may require a “destination location” parameter and a “return date” parameter. The dialog-based pipeline may generate text or graphical user interface (GUI) components to be presented to the user in one or more dialog turns. In the present example, the dialog-based pipeline may generate a prompt for the “destination location” parameter (e.g., a text-based natural language prompt, a GUI map component or drop-down list, etc.) and another prompt for the “return date” parameter (e.g., a second text-based prompt, a GUI calendar component, etc.). The dialog-based pipeline may also generate one or more prompts to confirm parameters that were determined based on recognized named entities (e.g., a text-based summary and prompt for confirmation, one or more interactive GUI components with determined parameters pre-selected, etc.). Once a sufficient set of parameters has been obtained and an API request has been generated, the dialog-based pipeline may send the API request to an application or system for execution. In the present example, the dialog-based pipeline may send the API request to a travel search application, and the travel search application may generate search results for presentation to the user. The natural language processing session may then continue or end.

The dialog-based pipeline may process many such natural language queries (e.g., thousands, hundreds of thousands, millions, or more), and may generate and store telemetry data about the processing. For example, the dialog-based pipeline may store, for each natural language processing session, the initial natural language query that triggered the natural language processing session, and the API request (and corresponding parameters) that was generated in response to the query. In some embodiments, additional telemetry data may be generated and stored, such as data reflecting the dialog turns between the initial query and final API request, context data about the natural language processing session (e.g., time, date, user identifier, etc.), and the like.

The telemetry data regarding the natural language processing sessions managed by the dialog-based pipeline may be used to generate training data for training a machine learning model that translates natural language queries into API requests. For example, a corpus of training data pairs may be generated from the telemetry data, whereby a single training data pair may include an initial natural language query of a session as a training data input item, and the final API request that was generated during the natural language processing session as a reference data output item that is the desired or “correct” output to be generated by the machine learning model from the training data input item. In some embodiments, additional data may be included in the training data input items, such as data reflecting additional dialog turns between the initial query and final API request, context data about the natural language processing session (e.g., time, date, user identifier, etc.) or user (e.g., demographics, interaction history, etc.). For example, interaction history may provide an indication of which travel reservations a user has made, whether a user is presently on a trip with which the current query may be associated, or the like. Such history may be used in determining parameter values for API requests and therefore used in translating the user's natural language processing queries into API requests.

A machine learning model may be trained using the training data generated from the telemetry data to generate an API request from a natural language query or some other natural language input. The trained model may be referred to as a natural-language-to-API model, or as an “NL2API model” for brevity. In some embodiments, the natural-language-to-API model may be a translation model implemented using an artificial neural network (NN) or a variant thereof, such as a deep neural network (DNN), a recurrent neural network (RNN), a convolutional neural network (CNN), a transformer, an encoder-decoder, an ensemble of multiple models, or some other model suitable for translation. The example machine learning model types and architectures described herein are illustrative only, and are not intended to be limiting, required, or exhaustive. In some embodiments, other types of models may be used, including those not based on NNs.

A model-based pipeline may be may be implemented for processing and responding to natural language queries using the trained natural-language-to-API model. The queries to be handled by the model-based pipeline may be the same type of queries as those handled by the dialog-based pipeline described above. For example, natural language text—either input by a user or generated by an ASR component—may be used as input into the trained natural-language-to-API model. Output of the model may be an API request, with a partial or full set of parameters, to be executed in response to the natural language input. The API request may then be executed directly, or a representation of the request or parameters thereof may be presented to the user for confirmation before execution. In this way, the natural-language-to-API model may be used to generate a starting point that can short-circuit the multi-turn dialog that would otherwise be used to obtain all needed parameters for a given API request.

The dialog-based pipeline may continue to be used to process some natural language queries after the model-based pipeline has been implemented. For example, the orchestrator may assign new natural language processing sessions to either the dialog-based pipeline or the model-based pipeline based on a randomized selection algorithm (e.g., using a pseudo-random number generator), based on a load balancing selection algorithm, based on test implementation logic such as A/B test logic, or the like.

The performance of a model-based pipeline may be evaluated alone, or in comparison with the dialog-based pipeline or another model-based pipeline. For example, metrics regarding computing resource efficiency, processing accuracy, latency, user experience, or other aspects of natural language query processing may be recorded for each natural language query processed (or a subset thereof). If the performance of a particular natural-language-to-API model falls below a threshold, or falls more than threshold degree behind that of the dialog-based pipeline or other natural-language-to-API models, then the particular natural-language-to-API model may be retrained, replaced, or be the subject of some other remedial action.

In some embodiments, the orchestrator may assign new natural language processing sessions based on past performance of particular natural-language-to-API models or pipelines processing similar natural language queries, users, or the like. For example, the orchestrator may implement a rules-based selection algorithm, or the orchestrator may use a selection model trained on prior performance of the available pipelines processing similar natural language queries. In this way, the processing of natural language queries may be further optimized for cases where a single model-based pathway does not provide optimal performance.

Various aspects of the disclosure will now be described with regard to certain examples and embodiments, which are intended to illustrate but not limit the disclosure. Although the examples and embodiments described herein will focus, for the purpose of illustration, on specific machine learning models, API requests, natural language processing pipelines, and algorithms, one of skill in the art will appreciate the examples are illustrative only, and are not intended to be limiting. In addition, any feature, process, device, or component of any embodiment described and/or illustrated in this specification can be used by itself, or with or instead of any other feature, process, device, or component of any other embodiment described and/or illustrated in this specification

### Example Natural Language Processing System

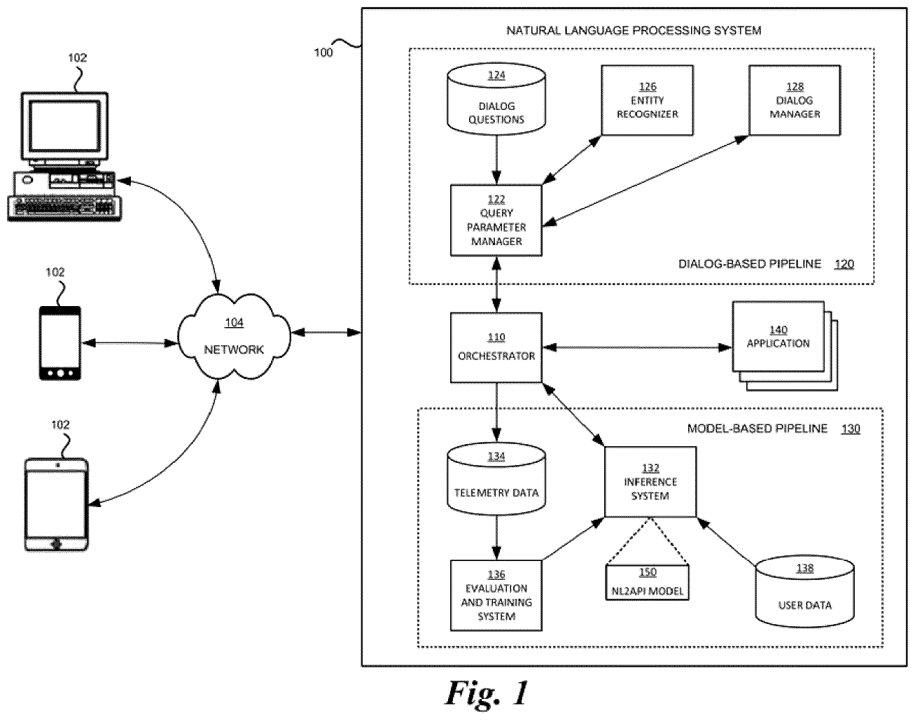

FIG. 1 illustrates an example natural language processing system 100 configured to process and respond to natural language queries, such as those received from various user devices 102 via a network 104. The network 104 may be or include a personal area network (PAN), local area network (LAN), wide area network (WAN), global area network (GAN), or some combination thereof, any or all of which may or may not have access to and/or from the internet.

User devices 102 may be or include any of a variety of computing devices configured to receive user input, communicate with the natural language processing system 100, and present output from the natural language processing system 100. For example, the user devices 102 may include mobile telephones with program execution and network communication capabilities (e.g. “smart phones”), wearable devices with program execution and network communication capabilities (e.g., “smart watches,” “smart eyewear”), tablet computing devices, electronic reader devices, handheld video game devices, media players, televisions with program execution and network communication capabilities (e.g., “smart TVs”), television set-top boxes, video game consoles, speakers with program execution and network communication capabilities (e.g., “smart speakers”), notebook computers, desktop computing devices, terminal computing devices, and the like.

The natural language processing system 100 may be configured to receive natural language input from various user devices 102 and generate responses or otherwise execute actions based on the natural language input. As shown, the natural language processing system 100 may include a plurality of components. In some embodiments, the natural language processing system 100 may include: an orchestrator 110 for orchestrating the processing of natural language queries, a dialog-based pipeline 120 to process natural language queries according to a chat-based multi-turn dialog paradigm, a model-based pipeline 130 to process natural language queries according to a machine learning model paradigm, and one or more applications 140 to execute the determined API requests in response to the natural language queries.

The dialog-based pipeline 120 may include various components for managing chat-based multi-turn dialogs. For example, the dialog-based pipeline 120 may include: a query parameter manager 122 to determine which parameters are needed to execute an API request and to facilitate obtaining those parameters; a dialog questions data store 124 that serves as a repository for questions or other prompts to obtain API request parameters or otherwise move a chat-based multi-turn dialog forward; an entity recognizer 126 to evaluate natural language input and identify named entities, such as those related to intents and API request parameters; a dialog manager 128 to dynamically generate responses or prompts (e.g., as an alternative or supplement to the dialog questions data store 124); and/or various other chat-based multi-turn dialog management components.

The model-based pipeline 130 may include various components for managing generation of API requests using a trained natural-language-to-API model in response to natural language queries. For example, the model-based pipeline 130 may include: an inference system 132 that uses a natural-language-to-API model 150 to generate or predict API requests in response to natural language queries; a telemetry data store 134 to store telemetry data regarding prior natural language processing sessions, including those conducted using the dialog-based pipeline 120; an evaluation and training system 136 to evaluate the performance of the natural-language-to-API model 150, other models 150, and the dialog-based pipeline; a user data store 138 to store and provide data that may be used by the inference system 132 and natural-language-to-API model 150 in addition to the natural language query input; and/or various other model-based dialog management components.

Individual components of the natural language processing system 100 may be implemented on one or more computing devices. For example, each component may be implemented on a separate computing device, or separate set of computing devices. As another example, a single computing device or set of computing devices may be shared among multiple components. In some embodiments, the features and services provided by the natural language processing system 100 may be provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment. In some embodiments, each component of the natural language processing system 100, or subsets of the components, may be implemented on different computing environments, any or all of which may or may not include a cloud computing environment.

### Example Training Data Generation Routine

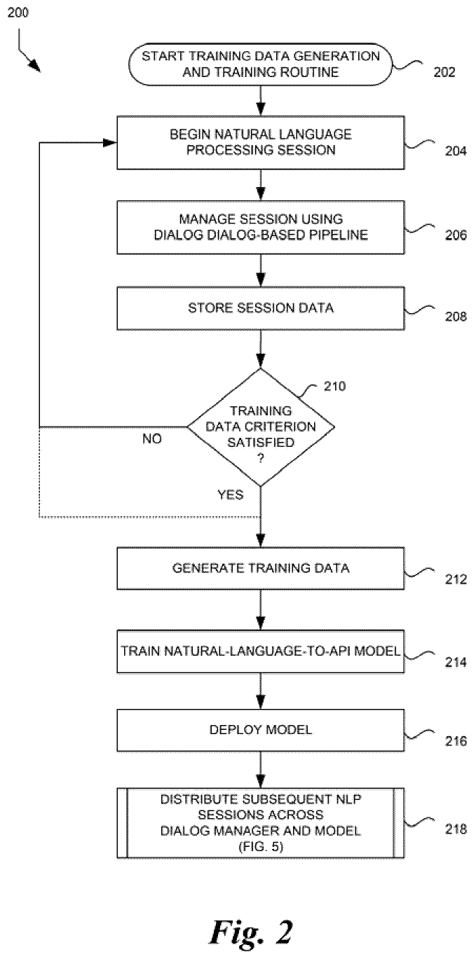

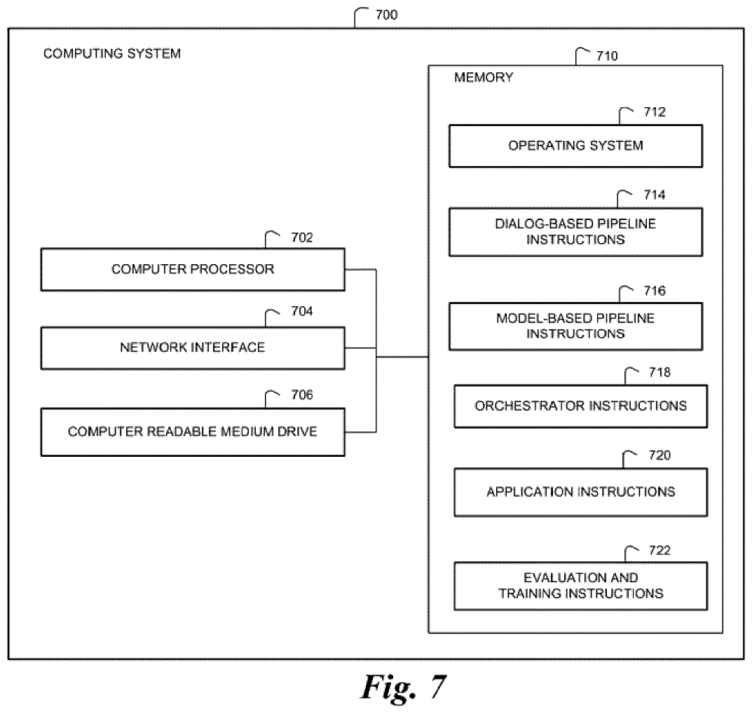

FIG. 2 illustrates an example routine 200 for generating training data using a dialog-based pipeline 120, and using the training data to train a natural-language-to-API model. Routine 200 begins at block 202. In some embodiments, routine 200 may begin in response to an event, such as the natural language processing system 100 beginning operation or being instructed to generate training data. When the routine 200 begins, executable instructions may be loaded to or otherwise accessed in computer readable memory and executed by one or more computing devices of the natural language processing system 100, such as the computing system 700 shown in FIG. 7.

At block 204, the orchestrator 110 or some other component of the natural language processing system 100 may begin a natural language processing session with a user device 102. The natural language processing session may begin in response to receipt of a natural language query from the user device 102, in response to establishment of a connection between the user device 102 and the natural language processing system 100, or in response to some other event.

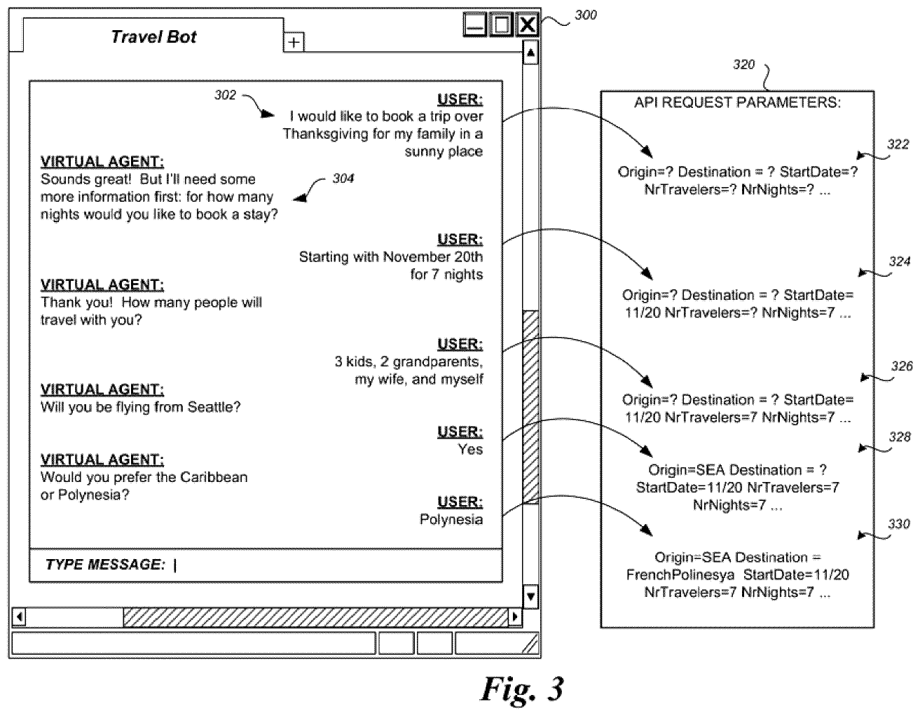

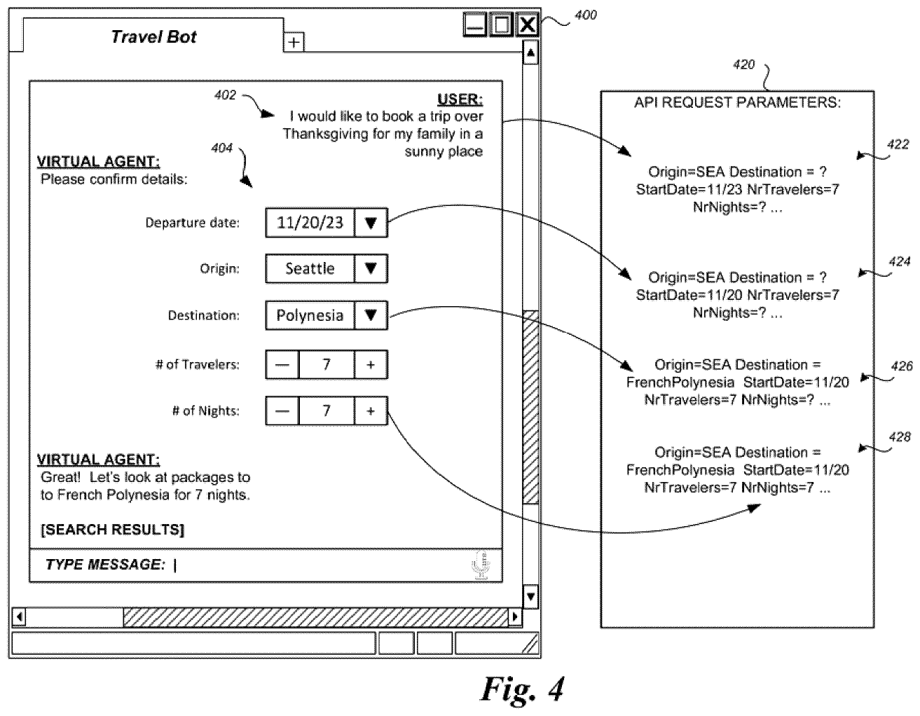

At block 206, the dialog-based pipeline 120 may manage the natural language processing session using one or more components of the dialog-based pipeline 120. For example, a query parameter manager 122 may employ an entity recognizer 126 to identify, in an initial natural language query and other natural language user inputs, information regarding parameters for an API request, or other information associated with the API request or from which the API request may otherwise be determined. The query parameter manager 122 may use a dialog questions data store 124 and/or a dialog manager 128 to generate prompts to the user for obtaining API request parameters and for otherwise generating an API request to be executed. The orchestrator 110 may then send the API request to an application 140 for execution. Example natural language processing sessions managed using the dialog-based pipeline 120 are shown in FIGS. 3 and 4.

FIG. 3 illustrates an example natural language processing session 300 processed using a dialog-based pipeline 120 to generate a set of processing results 320 as parameters for an API request. A user initiates the session by typing an initial query 302, or speaking and having an ASR system generate a textual version of the initial query 302. In this example, the initial query 302 is “I would like to book a trip over Thanksgiving for my family in a sunny place.” Although the desired response is not stated directly in the initial query 302, it is understood that the user would like to research possible travel packages that related to the stated criteria (“over Thanksgiving,” “my family,” “sunny place”).

Based on the initial query 302, the dialog-based pipeline 120 may determine a set of parameters that are to be determined in order to execute an API request. In this example, the dialog-based pipeline 120 determines a parameter set 322 associated with search for travel packages. In some embodiments, as described in greater detail below with respect to FIG. 4, the dialog-based pipeline 120 may also make an initial determination of one or more parameters based on the initial query. In the example shown in FIG. 3, the dialog-based pipeline has not made an initial determination of any parameters based on the initial query 302. Rather, the dialog-based pipeline 120 generates an initial response 304 to prompt the user for a parameter (“how many nights”). For example, the query parameter manager 122 may determine parameter set 322, and request the dialog questions data store 124 or dialog manager 128 to provide the prompt for the initial response 304. The user responds with information for two parameters (“November 20^{th})” and “7 nights”).

The entity recognizer 126 or some other component of the dialog-based pipeline 120 may identify values for the “StartDate” and “NrNights” parameters in the response from the user, and the query parameter manager 122 may generate parameter set 324 based thereon. The query parameter manager 122 may then request the dialog questions data store 124 or dialog manager 128 to provide a prompt for another parameter (“How many people will travel with you?”), to which the user responds with information for the parameter (“3 kids, 2 grandparents, my wife, and myself”).

The entity recognizer 126 or some other component of the dialog-based pipeline 120 may identify a value for the “NrTravelers” parameter in the response from the user, and the query parameter manager 122 may generate parameter set 326 based thereon. The query parameter manager 122 may then request the dialog questions data store 124 or dialog manager 128 to provide a prompt for another parameter (“Will you be flying from Seattle”). In this case, user data such as profile data or historical interaction data may be used to determine a typical origin for this user (Seattle) to be included in the prompt. The user responds with information for the parameter (“Yes”).

The entity recognizer 126 or some other component of the dialog-based pipeline 120 may determine that “Yes” confirms the value of “Seattle” for the “Origin” parameter, and the query parameter manager 122 may generate parameter set 328 based thereon. The query parameter manager 122 may then request the dialog questions data store 124 or dialog manager 128 to provide a prompt for another parameter (“Would you prefer the Caribbean or Polynesia”). In this case, user data such as profile data or historical interaction data may be used to determine a typical destination for this user (Caribbean or Polynesia), or potential destinations associated with a named entity in the initial query 302 (“in a sunny place”) may be selected to be included in the prompt. The user responds with information for the parameter (“Polynesia”). In some embodiments, usage data associated with the current user and/or a larger set of users may be evaluated to determine what the phrase “sunny place” might mean. The results may be used for automatic parameter determination, dialog prompts, or both.

The entity recognizer 126 or some other component of the dialog-based pipeline 120 may identify a value for the “Destination” parameter, and the query parameter manager 122 may generate parameter set 330 based thereon. The query parameter manager 122 may then determine that parameter set 330 is a complete parameter set, and may return the parameter set to the orchestrator 110 for execution. The orchestrator 110 may then cause execution of the API request. For example, the orchestrator 110 may send the API request to an application 140, such as a travel package search application, for execution.

FIG. 4 illustrates an example natural language processing session 400 processed using a dialog-based pipeline 120 to generate a set of processing results 420 as parameters for an API request. In contrast to the natural language processing session 300 shown in FIG. 3, the natural language processing session 400 shown in FIG. 4 may involve presentation of graphical user interface controls instead of—or in addition to—textual chat responses. Alternatively, or in addition, management of the natural language processing session 400 may involve an initial identification of one or more named entities in the initial natural language query, and use of the initially-identified named entities as default values in chat prompts.

In the illustrated example, a user initiates the session by typing an initial query 402, or speaking and having an ASR system generate a textual version of the initial query 402. In this example, the same initial query 402 is used as in the example discussed above (“I would like to book a trip over Thanksgiving for my family in a sunny place.”).

Based on the initial query 402, the dialog-based pipeline 120 may determine a set of parameters that are to be determined in order to execute an API request. In this example, the dialog-based pipeline 120 determines a parameter set 422 associated with search for travel packages. The dialog-based pipeline 120 may also make an initial determination of one or more parameters based on the initial query 402 alone, or in combination with user data from the user data store 138. For example, the entity recognizer 126 or some other component of the dialog-based pipeline 120 may identify the value for the “StartDate” parameter in the response from the user. As another example, the entity recognizer 126 or some other component of the dialog-based pipeline 120 may identify the term “my family” and look up, in the user data store 138, the number of travelers in the user's family that the user has traveled with in the past. As a further example, query parameter manager 122 may look up, in the user data store 138, the most used origin location for the user, even if an origin location was not mentioned or referred to in the initial query 302.

The query parameter manager 122 may add the determined parameters to the initial parameter set 422. The query parameter manager 122 may then generate one or more prompts for other parameters. In the illustrated example, the query parameter manager 122 may generate GUI controls 404 for each parameter in the initial parameter set 422, or some combination thereof. The parameters for which values have been preliminarily determined may have the values reflected in the presentation.

The dialog-based pipeline 120 may add or update parameters based on user interactions with the presented GUI controls. For example, the value for the “StartDate” parameter has been updated in parameter set 424 based on a change selected by the user. The value for “Destination” has been added in parameter set 426, and the value for “NrNights” has been added in final parameter set 428.

The query parameter manager 122 may determine that parameter set 428 is a complete parameter set, and may return the parameter set to the orchestrator 110 for execution. The orchestrator 110 may then cause execution of the API request. For example, the orchestrator 110 may send the API request to an application 140, such as a travel package search application, for execution.

The example natural language processing sessions shown in FIGS. 3 and 4 are illustrative only, and are not intended to be limiting, required, or exhaustive. In some embodiments, different interfaces, dialog flows, and query parameter determination processes may be used. For example, partial results may be presented during a session (such as session 300) based on the set of query parameters determined at different points in the session. As the session continues through subsequent dialog turns and additional parameters are determined, the results may be filtered or updated accordingly.

Returning to FIG. 2, at block 208 the orchestrator 110 may store data regarding the natural language processing session. The data regarding the natural language processing session may be referred to as telemetry data. The telemetry data for this session and any number of other sessions (e.g., thousands, hundreds of thousands, millions, or more) may later be used to train a natural-language-to-API model 150, as described in greater detail below.

For example, during or after completion of the natural language processing session 300 shown in FIG. 3, the orchestrator 110 may store telemetry data regarding the session in the telemetry data store 134. The orchestrator 110 may store telemetry data such as: a unique session identifier, the initial query 302, and the final parameter set 330 or the complete API call made to the application 140. As another example, during or after completion of the natural language processing session 400 shown in FIG. 4, the orchestrator 110 may store telemetry data regarding the session in the telemetry data store 134. The orchestrator 110 may store telemetry data such as: a unique session identifier, the initial query 402, and the final parameter set 428 or the complete API call made to the application 140. In some embodiments, telemetry data may include additional data, such as one or more of the natural language queries or responses made by the user after the initial query 302 or 402, one or more of the parameter sets determined by the dialog-based pipeline 120 prior to the final parameter set 330 or 428, context data about the natural language processing session (e.g., time, date, user identifier, etc.), or the like.

At decision block 210, the orchestrator or some other component of the natural language processing system 100 may determine whether a criterion for generation of training data is satisfied. In some embodiments, the criterion may be performance of a threshold quantity of natural language processing sessions or storage of a threshold quantity of initial natural language queries and corresponding API requests generated from the initial natural language queries. If the training data criterion has been satisfied, the routine 200 may proceed to block 212. Otherwise, the routine 200 may return to block 204 for management of additional natural language processing sessions. In some embodiments, the portion of routine 200 beginning at block 212 may be performed in parallel or asynchronously with respect to additional iterations of the portion of routine 200 from block 204 to block 208.

At block 212, the evaluation and training system 136 or some other component of the natural language processing system 100 may generate training data to train a natural-language-to-API model 150. The training data may be generated from telemetry data associated with natural language processing sessions managed using the dialog-based pipeline 120.

In some embodiments, a corpus of training data pairs may be generated from the telemetry data. A training data pair may include a training data input item, and a corresponding reference data output item that is the desired output of the model for the training data input item. A training data input item may be a string comprising an initial natural language query of a session, or a representation thereof suitable for input into a model. For example, a training data input item may be a vector including the initial query string converted into numeric values for each character. As another example, the training data input item may be a vector including a tokenized version of the initial query, such as a different numeric token representation of each word or phrase in the initial query. As a further example, the training data input item may be a vector including word embeddings for each word (e.g., BERT word embeddings) of the input query, or a sentence embedding for the initial query as a whole (e.g., a BERT sentence embedding).

In some embodiments, additional input data such as query context data may be included in the training data input item. For example, a context vector may be generated using data regarding the session (e.g., time, date, user identifier, additional dialog turns, etc.). As another example, a context vector may include data about the user, such as data from the user data store 138 (e.g., profile data, demographic data, historical interaction data, etc.). The context vector may be appended to the vector representing the initial query to generate an augmented input vector to be used as a training data input item.

A reference data output item may be a string comprising an API request that is the desired output from the training data input item. For example, the reference data output item may be a fully-formed API request with parameters. As another example, the reference data output item may be a set of values or tokens from which a string representation of the desired API request may be derived.

At block 214, the evaluation and training system 136 may train a natural-language-to-API model 150 using the corpus of training data generated from the telemetry data. In some embodiments, the natural-language-to-API model 150 may be a translation model implemented using an artificial neural network or a variant thereof, such as an RNN, a CNN, a transformer, an encoder-decoder, an ensemble of multiple models, or some other model suitable for translation. The example machine learning model types and architectures described herein are illustrative only, and are not intended to be limiting, required, or exhaustive.

Generally described, NNs—including DNNs, CNNs, RNNs, and other NN-based models such as transformers and encoder-decoder models—have multiple layers of nodes, also referred to as neurons. Illustratively, a NN may include an input layer, an output layer, and any number of intermediate, internal, or “hidden” layers between the input and output layers. The individual layers may include any number of separate nodes. Nodes of adjacent layers may be logically connected to each other, and each logical connection between the various nodes of adjacent layers may be associated with a respective weight. Conceptually, a node may be thought of as a computational unit that computes an output value as a function of a plurality of different input values. Nodes may be considered to be connected when the input values to the function associated with a current node include the output of functions associated with nodes in a previous layer, multiplied by weights associated with the individual connections between the current node and the nodes in the previous layer. When a NN is used to process input data in the form of an input vector or a matrix of input vectors (e.g., a batch of training data input vectors), the NN may perform a “forward pass” to generate an output vector or a matrix of output vectors, respectively. The input vectors may each include n separate data elements or dimensions, corresponding to the n nodes of the NN input layer (where n is some positive integer). Each data element may be a value, such as a floating-point number or integer. A forward pass typically includes multiplying the matrix of input vectors by a matrix representing the weights associated with connections between the nodes of the input layer and nodes of the next layer, and applying an activation function to the results. The process is then repeated for each subsequent NN layer. Some NNs have hundreds of thousands or millions of nodes, and millions of weights for connections between the nodes of all of the adjacent layers.

The connections between individual nodes of adjacent layers are each associated with a trainable parameter, such as a weight and/or bias term, that is applied to the value passed from the prior layer node to the activation function of the subsequent layer node. For example, the weights associated with the connections from an input layer to an internal layer to which it is connected may be arranged in a weight matrix W with a size m×n, where m denotes the number of nodes in the internal layer and n denotes the dimensionality of the input layer. The individual rows in the weight matrix W may correspond to the individual nodes in the input layer, and the individual columns in the weight matrix W may correspond to the individual nodes in the internal layer. The weight w associated with a connection from any node in the input layer to any node in the internal layer may be located at the corresponding intersection location in the weight matrix W.

Illustratively, a training data input item structured as—or converted into—an input vector (or augmented input vector, as described above) may be provided to a computer processor that stores or otherwise has access to the weight matrix W. The processor then multiplies the input vector by the weight matrix W to produce an intermediary vector. The processor may adjust individual values in the intermediary vector using an offset or bias that is associated with the internal layer (e.g., by adding or subtracting a value separate from the weight that is applied). In addition, the processor may apply an activation function to the individual values in the intermediary vector (e.g., by using the individual values as input to a sigmoid function or a rectified linear unit (ReLU) function). In some embodiments, there may be multiple internal layers, and each internal layer may or may not have the same number of nodes as each other internal layer. The weights associated with the connections from one internal layer to the next internal layer may be arranged in a weight matrix similar to the weight matrix W. The process of multiplying intermediary vectors by weight matrices and applying activation functions to the individual values in the resulting intermediary vectors may be performed for each internal layer subsequent to the initial internal layer. The output layer of a NN makes output determinations from the last internal layer alone, or in combination with information from prior internal layers, etc.

A reference data output item structured as—or converted into—an output vector may include the “correct” or otherwise desired output that a model 150 should produce for the corresponding training data input item, as described above. The goal of training may be to minimize the difference between output vectors (generated by the model from training data input items) and corresponding reference data output vectors. Evaluation of training data output vectors with respect to the reference data output vectors may be performed using a loss function (also referred to as an objective function), such as a binary cross entropy loss function, a weighted cross entropy loss function, a squared error loss function, a softmax loss function, some other loss function, or a composite of loss functions. A gradient of the loss function with respect to the parameters (e.g., weights) of the model may be computed. The gradient can be used to determine the direction in which individual parameters of the model 150 are to be adjusted in order to minimize the loss function and, therefore, minimize the degree to which future output (e.g., training data output vectors) differs from expected or desired output (reference data output vectors). The degree to which individual parameters are adjusted may be predetermined or dynamically determined (e.g., based on the gradient and/or a hyperparameter). For example, a hyperparameter such as a learning rate may specify or be used to determine the magnitude of the adjustment to be applied to individual parameters of the model 150.

In some embodiments, the model training system can compute the gradient for a subset of the training data, rather than the entire set of training data. Therefore, the gradient may be referred to as a “partial gradient” because it is not based on the entire corpus of training data. Instead, it is based on the differences between the training data output vectors and the reference data output vectors when processing only a particular subset of the training data.

In some embodiments, the model training system can update some or all parameters of the model 150 using a gradient descent method with back propagation. In back propagation, a training error is determined using a loss function (e.g., as described above). The training error may be used to update the individual parameters of the model in order to reduce the training error. For example, a gradient may be computed for the loss function to determine how the weights in the weight matrices are to be adjusted to reduce the error. The adjustments may be propagated back through the model 150 layer-by-layer.

The evaluation and training system 136 can manage the training process by evaluating one or more stopping criteria. For example, a stopping criterion can be based on the accuracy of the model 150 as determined using the loss function, a test set, or both. If the accuracy satisfies a threshold or other criterion, the model 150 may be considered to have “converged” on a desired or adequate result and the training process may be stopped. As another example, a stopping criterion can be based on the number of iterations (e.g., “epochs”) of training that have been performed, the elapsed training time, or the like.

The example training process described herein is illustrative only, and is not intended to be limiting, required, or exhaustive. In some embodiments, the training process may include additional, fewer, and/or alternative steps, depending upon type of model being trained, the application for which the model is being trained, etc.

At block 216, the trained natural-language-to-API model 150 may be deployed for use in processing natural language queries. For example, the evaluation and training system 136 can send the model (e.g., a file of the parameters of the model, executable code for implementing the model algorithm, etc.) to the inference system 132 for use.

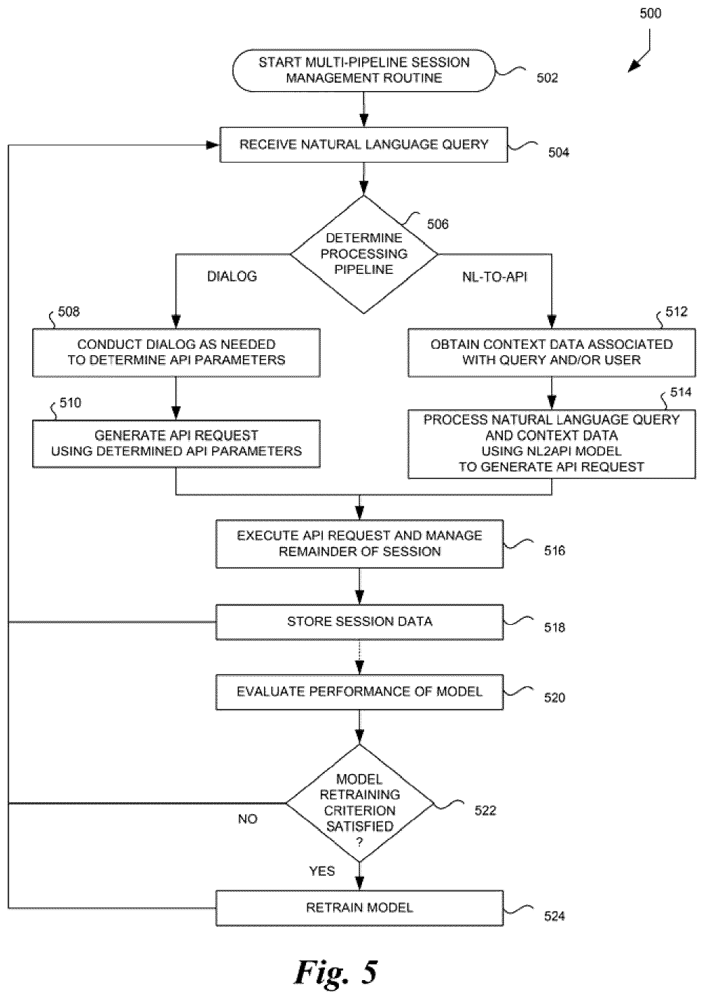

At block 218, the orchestrator may distribute subsequent natural language processing sessions among the dialog-based pipeline 120 and model-based pipeline 130 for processing. An example routine for distributing sessions in this manner is shown in FIG. 5 and described in greater detail below.

In some embodiments, multiple natural-language-to-API models 150 may be trained. For example, different structures may be used, such as one RNN-based model, one encoder-decoder model, etc. As another example, different sets of training data, different training algorithms, different training hyperparameters, or different combinations thereof may be used. The multiple models may be used to effectively implement multiple model-based pipelines 130.

### Example Multi-Pipeline Session Management Routine

FIG. 5 illustrates an example routine 500 for distributing natural language processing sessions among multiple natural language processing pipelines, including a model-based pipeline 130 implementing a natural-language-to-API model 150. Routine 500 begins at block 502. In some embodiments, routine 500 may begin in response to an event, such as the natural language processing system 100 beginning operation or after deployment of a trained natural-language-to-API model 150. When the routine 500 begins, executable instructions may be loaded to or otherwise accessed in computer readable memory and executed by one or more computing devices of the natural language processing system 100, such as the computing system 700 shown in FIG. 7.

At block 504, the orchestrator 110 or some other component of the natural language processing system 100 may receive a natural language query from a user device 102, and may begin a natural language processing session.

At decision block 506, the orchestrator 110 may determine which processing pipeline of the multiple available processing pipelines is to be assigned to manage the natural language processing session. Although FIG. 5 shows the orchestrator 110 determining between a dialog-based pipeline 120 and a model-based pipeline 130, the illustration is provided for purposes example only, and is not intended to be limiting, required, or exhaustive. In some embodiments, the orchestrator 110 may determine between multiple model-based pipelines 130 (e.g., different pipelines each with a different natural-language-to-API model 150, or a single pipeline configured to use any of multiple different natural-language-to-API models 150). In some embodiments, the orchestrator 110 may determine between multiple dialog-based pipelines 120 (e.g., one dialog-based pipeline 120 configured to use a dialog questions data store 124, and another dialog-based pipeline 120 configured to use a generative-AI-based dialog manager 128) instead of, or in addition to one or more model-based pipelines 130.

In one example, the orchestrator 110 may select a pipeline based on a randomized selection algorithm (e.g., using a pseudo-random number generator). As another example, the orchestrator 110 may select a pipeline based on a load balancing algorithm (e.g., based on which pipeline has the fewest connections open, based on metrics of available computing resources, based on a round robin algorithm, etc.). As a further example, the orchestrator 110 may select a pipeline using a selection model that considers the natural language input and/or information associated therewith (e.g., user, time of day, initial classification of natural language query subject, etc.) and selects the pipeline that is most likely to provide satisfactory performance (e.g., measured in terms of user satisfaction, resource usage, etc.). The example pipeline selection algorithms described herein are illustrative only, and are not intended to be limiting, required, or exhaustive. In some embodiments, additional or alternative selection algorithms may be used.

At block 508, in the event that the orchestrator 110 has assigned the natural language processing session to the dialog-based pipeline 120, the dialog-based pipeline 120 conducts the session to determine parameters for the API request to be generated. At block 510, the dialog-based pipeline 120 uses the determined parameters to generate the API request that is to be executed. Examples of natural language processing sessions managed using a dialog-based pipeline 120 are shown in FIGS. 3 and 4, and are described in greater detail above.

At block 512, in the event that the orchestrator 110 has assigned the natural language processing session to the model-based pipeline 130, the model-based pipeline 130 may begin by obtaining context data associated with the natural language query and/or the user. For example, context data may include data regarding the session (e.g., time, date, user identifier, etc.). As another example, context data may include data about the user or user device 102 from which the natural language query was received, such as data from the user data store 138 (e.g., profile data, demographic data, historical interaction data, etc.). In some embodiments, no context data is used and block 512 is not executed.

In some embodiments, one or more dialog turns may be performed to obtain parameters for the API request to be generated, or to obtain data from which parameters for the API request may be determined. For example, a dialog management and/or a dialog questions data store may be used to generate a prompt for additional information.

At block 514, the inference system 132 or some other component of the model-based pipeline 130 may process the natural language query and (optionally) context data using a natural-language-to-API model 150 to generate an API request to be executed.

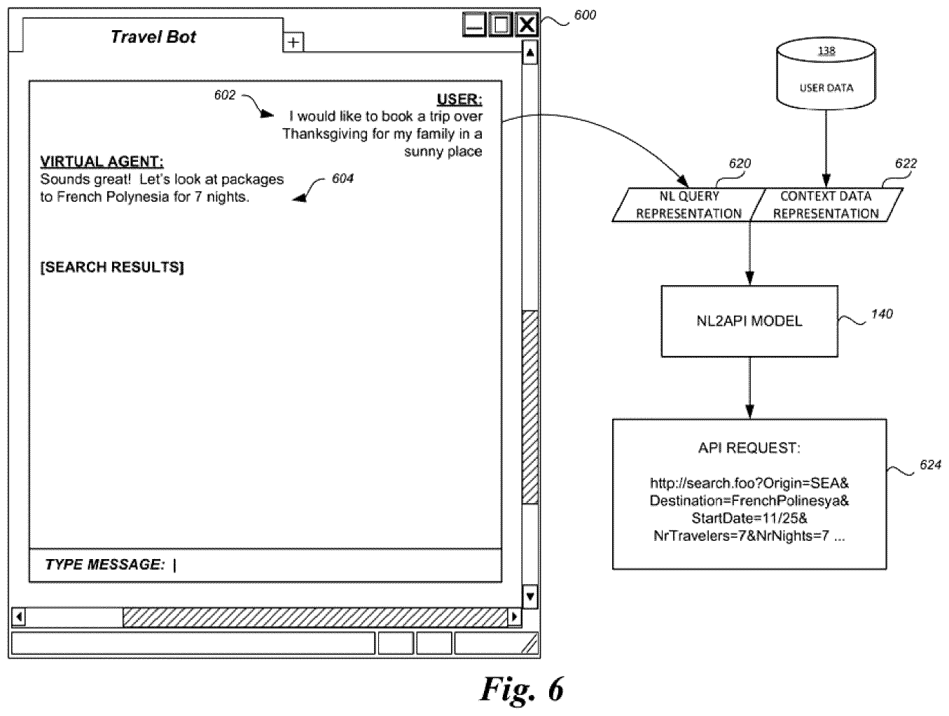

FIG. 6 illustrates an example natural language processing session 600 processed using a model-based pipeline 130 to predict or otherwise generate an API request 624 including a set of parameters. In contrast to sessions managed using the dialog-based pipeline 120 (e.g., the natural language processing sessions 300 and 400 shown in FIGS. 3 and 4), the natural language processing session 600 may involve presentation of search results 604 (or other results of an executed API request) after an initial query 602, without necessarily proceeding with a multi-turn dialog.

In the illustrated example, a user initiates the session by typing an initial query 602, or speaking and having an ASR system generate a textual version of the initial query 602. In this example, the same initial query 602 is used as in the examples discussed above (“I would like to book a trip over Thanksgiving for my family in a sunny place.”).

Based on the initial query 602, the inference system 132 or some other component of the model-based pipeline 130 may generate input for analysis by a natural-language-to-API model 150. In this example, the inference system 132 generates a natural language query representation 620, such as a vector. The natural language query representation 620 may include the text of the initial query 602 in numeric form. For example, the natural language query representation 620 may include the initial query string converted into numeric values for each character. As another example, the natural language query representation 620 may include a tokenized version of the initial query 602, such as a different numeric token-based representation of each word or phrase in the initial query 602. As a further example, the natural language query representation 620 may include word embeddings for each word (e.g., BERT word embeddings), or a sentence embedding for the initial query 402 (e.g., a BERT sentence embedding).

In some embodiments, additional data such as query context data may be included as input into the natural-language-to-API model 150. For example, the inference system 132 may generate a context data representation 622, such as a vector, using data regarding the initial query 602 or session 600 (e.g., time, date, user identifier, etc.). As another example, the inference system 132 may include data about the user, such as data from the user data store 138 (e.g., profile data, demographic data, historical interaction data, etc.).

The natural language query representation 620—augmented by appending a context data representation 622, if being used—may be processed by the natural-language-to-API model 150 to generate an API request 624. In some embodiments, the API request 624 may be generated as a fully-formed request with parameters, as illustrated. In some embodiments, the output of the natural-language-to-API model 150 may be a set of values or tokens. For example, the natural-language-to-API model 150 may generate output representing the API request to be made (e.g., a call to the “search.foo” uniform resource locator in this example), and a set of parameter values for the parameters associated with the API request (e.g., “SEA,” “FrenchPolynesia,” “11/25,” “7,” and “7” in this example). The inference system 132 may assemble the final API request 624 from the model output, or the model output may be provided to the orchestrator 110 or some other component for assembly into the final API request 624 to be executed. The orchestrator 110 may then cause execution of the API request 624. For example, the orchestrator 110 may send the API request 624 to an application 140, such as a travel package search application, for execution.

Returning to routine 500, at block 516 the orchestrator 110 may execute the API request or send the API request to an application 140 for execution, and continue with management of the session. In some embodiments, management of the session may involve additional dialog turns, and potentially additional natural language queries that are processed using one of the natural language processing pipelines. The natural language processing pipeline may be the same pipeline as that which processed the initial natural language query of the session, or the routine 500 may return to block 504 with each new natural language query.

In some embodiments, execution of the API request may return one or more errors instead of—or in addition to—a response. If certain errors are received, one or more dialog turns may be performed to obtain parameters for the API request to be generated, or to obtain data from which parameters and/or the API request may be determined. For example, a dialog management and/or a dialog questions data store may be used to generate a prompt for additional information.

At block 518, the orchestrator 110 or some other component of the natural language processing system 100 may store session data regarding the session that has been managed in the current iteration of routine 500. For example, during or after completion of the natural language processing session, the orchestrator 110 may store telemetry data such as: a unique session identifier, the initial query, the API request(s) generated during the session, performance data (e.g., time elapsed to generate API request(s), number of dialog turns conducted before generation of the API request(s), computing resources used to generate API request(s)), user experience data (an indicator of whether the session was abandoned, an indicator of user engagement during or as a result of the session), etc.

At block 520, the evaluation and training system 136 may evaluate performance of model (and/or one or more pipelines). The performance of a given model or pipeline may be evaluated over a set of multiple sessions, such as dozens, hundreds, thousands, or more. In some embodiments, the evaluation and training system 136 may determine one or more metrics from telemetry data stored for the sessions being used in the evaluation. For example, the evaluation and training system 136 may determine statistics such as the average, median, standard deviation, etc. for one or more of: time elapsed to generate API request(s); number of dialog turns conducted before generation of the API request(s); computing resources used to generate API request(s)); an engagement metric representing user engagement during or as a result of the session; or some other metric(s).

At decision block 522, the evaluation and training system 136 may determine whether a model retraining criterion has been satisfied. In some embodiments, the model retaining criterion may relate to a threshold for one or more metrics determined in block 520. For example, if a metric falls below a threshold value (e.g., user engagement) or exceeds a threshold value (e.g., time elapsed, number of dialog turns), then the model training criterion may be satisfied and the routine 500 may proceed to block 524. As another example, if a metric falls more than a threshold amount behind a similar metric for another pipeline (e.g., the engagement for sessions managed using the model-based pipeline 130 falls more than a threshold amount behind the engagement for sessions management using another model-based pipeline 130 or a dialog-based pipeline 120), or if a metric exceeds a similar metric for another pipeline by more than a threshold amount (e.g., the elapsed time for sessions managed using the model-based pipeline 130 exceeds the elapsed time for sessions managed using another model-based pipeline 130 or a dialog-based pipeline 120), then the model training criterion may be satisfied and the routine 500 may proceed to block 524.

In some embodiments, the model retraining criterion may not necessarily relate to performance metrics. Rather, the model retraining criterion may be time-based or data-quantity-based. For example, retraining of a model may be triggered on a periodic basis, such as every day, week, month, annual quarter, etc. As another example, retraining of a model may be triggered once a threshold amount of telemetry data has been stored and from which new training data may be generated.

At block 524, the evaluation and training system 136 may retrain a natural-language-to-API model 150. In some embodiments, the evaluation and training system 136 may re-execute the training process by which the a natural-language-to-API model 150 was originally trained, as described in greater detail above. For example, the evaluation and training system 136 may use telemetry data for more recently conducted natural language processing sessions to generate a corpus of training data and retrain the model 150. After retraining of the a natural-language-to-API model 150, it may be redeployed and used in subsequent iterations of routine 500.

### Execution Environment

FIG. 7 illustrates various components of an example computing system 700 configured to implement various functionality described herein. The computing system 700 may be or include one or more physical host computing devices.

In some embodiments, as shown, a computing system 700 may include: one or more computer processors 702, such as physical central processing units (CPUs); one or more network interfaces 704, such as a network interface cards (NICs); one or more computer readable medium drives 706, such as a high density disk (HDDs), solid state drives (SSDs), flash drives, and/or other persistent non-transitory computer readable media; and one or more computer readable memories 710, such as random access memory (RAM) and/or other volatile non-transitory computer readable media.

The computer readable memory 710 may include computer program instructions that one or more computer processors 702 execute and/or data that the one or more computer processors 702 use in order to implement one or more embodiments. For example, the computer readable memory 710 can store an operating system 712 to provide general administration of the model training system 700. As another example, the computer readable memory 710 can store dialog-based pipeline instructions 714 for implementing the systems, components, and features of a dialog-based pipeline 120. As another example, the computer readable memory 710 can store model-based pipeline instructions 716 for implementing the systems, components, and features of a model-based pipeline 130. As another example, the computer readable memory 710 can store orchestrator instructions 718 for implementing the features of an orchestrator 110. As another example, the computer readable memory 710 can store application instructions 720 for implementing the features of an application 140 that executes API requests generated by a dialog-based pipeline 120 or model-based pipeline 130. As another example, the computer readable memory 710 can store evaluation and training instructions 722 for implementing the features of an evaluation and training system 136.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
computer-readable memory storing executable instructions; and
one or more processors programmed by the executable instructions to at least:
manage a plurality of natural language processing sessions, wherein a natural language processing session of the plurality of natural language processing sessions comprises:
receipt of a natural language query;
generation of one or more natural language prompts for parameter data associated with an application programming interface (API) request to be executed;
receipt of one or more corresponding natural language responses to the one or more natural language prompts; and
execution of the API request;
generate a corpus of training data based on the plurality of natural language processing sessions, wherein the corpus of training data comprises a plurality of training data input vectors and a plurality of reference data output vectors, wherein a reference data output vector of the plurality of reference data output vectors represents the API request as a desired output to be generated from a training data input vector, of the plurality of training data input vectors, representing the natural language query; and
train a natural-language-to-API model using the corpus of training data, wherein the natural-language-to-API model is trained to generate API requests using natural language query input.

2. The system of claim 1, wherein the API request comprises a search query regarding a travel reservation.

3. The system of claim 1, wherein a particular API request generated by the natural-language-to-API model comprises a string representing a plurality of parameters, and wherein a natural language query input, used by the natural-language-to-API model to generate the particular API request, represents fewer than all of the plurality of parameters.

4. The system of claim 1, wherein the training data input vector represents both the natural language query and context data regarding a user account associated with the natural language query.

5. The system of claim 4, wherein the natural-language-to-API model is trained to generate a particular API request using both natural language query input and context data input associated with the natural language query input.

6. The system of claim 1, wherein the one or more processors are further programmed by the executable instructions to send, to an inference system, the natural-language-to-API model.

7. The system of claim 1, wherein the one or more processors are further programmed by the executable instructions to:
manage a second plurality of natural language processing sessions using the natural-language-to-API model;
evaluate performance of the natural-language-to-API model based on management of the second plurality of natural language processing sessions; and
determine, based on evaluation of the performance of the natural-language-to-API model, to retrain the natural-language-to-API model.

8. The system of claim 1, wherein the one or more processors are further programmed by the executable instructions to:
determine, for a first subset of natural language processing sessions of a second plurality of natural language processing sessions, to manage each natural language processing session of the first subset using the natural-language-to-API model; and
determine, for a second subset of natural language processing sessions of the second plurality of natural language processing sessions, to manage each natural language processing session of the second subset using a dialog-based query parameter manager.

9. The system of claim 8, wherein the one or more processors are further programmed by the executable instructions to use a selection model to determine whether a natural language processing session of the second plurality of natural language processing sessions is to be managed using the natural-language-to-API model or the dialog-based query parameter manager.

10. The system of claim 8, wherein the one or more processors are further programmed by the executable instructions to determine, for a third subset of natural language processing sessions of the second plurality of natural language processing sessions, to manage each natural language processing session of the third subset of natural language processing sessions using a second natural-language-to-API model different from the natural-language-to-API model.

11. The system of claim 10, wherein the one or more processors are further programmed by the executable instructions to:
evaluate performance of the natural-language-to-API model based on management of the first subset of natural language processing sessions;
evaluate performance of the second natural-language-to-API model based on management of the third subset of natural language processing sessions; and
determine, based on performance of the natural-language-to-API model exceeding performance of the second natural-language-to-API model by a threshold amount, to retrain the second natural-language-to-API model.

12. The system of claim 1, wherein the natural-language-to-API model comprises one of: a transformer-based artificial neural network, a recurrent neural network, a convolutional neural network, or an encoder-decoder machine learning model.

13. A computer-implemented method comprising:
under control of a computing system comprising one or more processors configured to execute specific instructions,
obtaining a corpus of training data based on a plurality of natural language processing sessions, wherein the corpus of training data comprises a plurality of training data input vectors and a plurality of reference data output vectors, wherein a reference data output vector of the plurality of reference data output vectors represents a travel-based search request as a desired output to be generated from a training data input vector, of the plurality of training data input vectors, representing a natural language query regarding a travel reservation; and
training a natural-language-to-API model using the corpus of training data, wherein the natural-language-to-API model is trained to generate predicted travel-bases search requests using natural language query input.

14. The computer-implemented method of claim 13, wherein training the natural-language-to-API model comprises generating a particular API request comprising a string representing a plurality of parameters, and wherein a natural language query input, used by the natural-language-to-API model to generate the particular API request, represents fewer than all of the plurality of parameters.

15. The computer-implemented method of claim 13, wherein the training data input vector represents both the natural language query and context data regarding a user account associated with the natural language query, and wherein training the natural-language-to-API model comprises training the natural-language-to-API model to generate a particular API request using both natural language query input and context data input associated with the natural language query input.

16. The computer-implemented method of claim 13, further comprising sending the natural-language-to-API model to an inference system.

17. A computer-implemented method comprising:
under control of a computing system comprising one or more processors configured to execute specific instructions,
receiving a natural language query;
generating natural-language-to-API model input representing at least a portion of the natural language query;
generating model output using a natural-language-to-API model and the natural-language-to-API model input, wherein the model output represents an API request to be executed in response to the natural language query; and
executing the API request.

18. The computer-implemented method of claim 17, further comprising:
determining, for a first subset of natural language processing sessions of a plurality of natural language processing sessions, to manage each natural language processing session of the first subset using the natural-language-to-API model; and
determine, for a second subset of natural language processing sessions of the plurality of natural language processing sessions, to manage each natural language processing session of the second subset using a dialog-based query parameter manager.

19. The computer-implemented method of claim 18, further comprising using a selection model to determine whether a natural language processing session of the plurality of natural language processing sessions is to be managed using the natural-language-to-API model or the dialog-based query parameter manager.

20. The computer-implemented method of claim 18, further comprising:
determining, for a third subset of natural language processing sessions of the plurality of natural language processing sessions, to manage each natural language processing session of the third subset of natural language processing sessions using a second natural-language-to-API model different from the natural-language-to-API model;
evaluating performance of the natural-language-to-API model based on management of the first subset of natural language processing sessions;
evaluating performance of the second natural-language-to-API model based on management of the third subset of natural language processing sessions; and
determining, based on performance of the natural-language-to-API model exceeding performance of the second natural-language-to-API model by a threshold amount, to retrain the second natural-language-to-API model.
